(19) United States
(12) Patent Application Publication
(10) Pub. No.: US 2003/0137902 A1
(43) Pub. Date: Jul. 24, 2003

(54) Hand motion irregularity suppressed timepiece

(76) Inventors: Mamoru Watanabe, Chiba-shi (JP); Yuichi Shino, Chiba-shi (JP); Tamotsu Ono, Chiba-shi (JP); Kei Hirano, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/339,071

(22) Filed: Jan. 9, 2003

(30) Foreign Application Priority Data
Jan. 18, 2002 (JP) 2002-009544

(51) Int. Cl. G04B 5/00

(52) U.S. Cl. 368/207

(57) ABSTRACT

To provide a hand motion irregularity suppressed timepiece whose assembling ability has been improved. As to a spring having a flat portion and a bent portion, the flat portion is disposed between a second chronograph wheel and a center wheel, and the bent portion is sandwiched and supported under a pressurized state by a train wheel bridge and a bottom plate. By this, the spring portion prevents a hand motion irregularity of the second chronograph wheel by the fact that the second chronograph wheel is pressure-contacted with the train wheel bridge. Further, by forming a gap between the second chronograph wheel and the center wheel, an accompanying rotation between the second chronograph wheel and the center wheel is prevented.

### BACKGROUND OF THE INVENTION

The present invention relates to a hand motion irregularity suppressed timepiece having an indicating hand for showing a time or elapsed time such as a minute hand or second hand.

Hitherto, in a timepiece such as primarily a chronograph, there has been used a hand motion irregularity suppression structure for suppressing an irregular motion of the hand.

FIG. 4 is a front view showing a conventional, hand motion irregularity suppressed timepiece, and shows an example of chronograph. Further, FIG. 5 is a partial plan view of FIG. 4. Incidentally, FIG. 4 and FIG. 5 are views each showing a state after an assembly of parts such as a wheel has been completed.

In FIG. 4 and FIG. 5, a second chronograph wheel 102 and a center wheel 104 are disposed between a train wheel bridge 101 and a bottom plate 106. A shaft 105 is integrally formed in the second chronograph wheel 102, the center wheel 104 is inserted through the shaft 105, and thus the second chronograph wheel 102 and the center wheel 104 are coaxially disposed. The second chronograph wheel 102 is meshed with a second chronograph intermediate wheel 103.

A plate-like spring 401 for suppressing the hand motion irregularity of the second chronograph wheel 102 is disposed between the second chronograph wheel 102 and the center wheel 104.

The spring 401 is formed in a long plate-like form, and in its center portion there is formed a through-hole 402 and in its both end portions there are formed through-holes 404, 406. The through-hole 402 is inserted through the shaft 105, and the through holes 404, 406 are so disposed that they are respectively fitted to convex portions 403, 405 formed in the bottom plate 106.

The spring member 401 is constituted such that its center portion is deflected above (train wheel bridge 101 side) in FIG. 1 with respect to its both end portions and, after the assembly has been completed, functions such that the center portion of the spring 401 causes the second chronograph wheel 102 to pressure-contact with the train wheel bridge 101 as shown in FIG. 4. By this, the hand motion irregularity of the second chronograph wheel 102 is suppressed.

Further, since a gap is formed between the second chronograph wheel 102 and the center wheel 104, it becomes possible to prevent the second chronograph wheel 102 from being rotated (so-called accompanying rotation) by a friction when the center wheel 104 is rotated.

However, with the conventional, hand motion irregularity suppression structure mentioned above, there is a problem that an assembling ability is inferior.

FIG. 6 is a view showing an assembling process of the conventional timepiece mentioned above, and the same reference numeral is given to the same portion as FIG. 4 and FIG. 5.

As shown in FIG. 6, since it is necessary that the second chronograph wheel 102 and the second chronograph intermediate wheel 103 are assembled on the deflected spring 401, unless the spring 401 is pushed to the bottom plate 106 side when assembling the second chronograph wheel 102 and the like, the second chronograph wheel 102 does not mesh with the second chronograph intermediate wheel 103. Accordingly, since the assembly must be performed while meshing the second chronograph wheel 102 with the second chronograph intermediate wheel 103 under a state that the spring 401 is pushed to the bottom plate 106 side, there is the problem that the assembling ability is inferior.

A subject of the present invention is to provide a hand motion irregularity suppressed timepiece whose assembling ability is improved.

### SUMMARY OF THE INVENTION

According to the present invention, there is provided a hand motion irregularity suppressed timepiece characterized in that—in a timepiece adapted such that a 1st wheel and a 2nd wheel, which are coaxially disposed, and a 3rd wheel meshing with the 1st wheel are disposed between a 1st support member and a 2nd support member, and an indicating hand is rotated by rotation-driving each of the wheels—there is provided a spring disposed between the 1st and 2nd wheels and having a flat portion and a bent portion formed in one end portion of the flat portion, and the 1st wheel is pressure-contacted with the 1st support member existing at a side opposite to the 2nd wheel by the fact that the flat portion of the spring is disposed between the 1st and 2nd wheels and the bent portion is sandwiched and supported under a pressurized state by the 1st and 2nd support members. By the fact that the flat portion of the spring is disposed between the 1st and 2nd wheels and the bent portion is sandwiched and supported under a pressurized state by the 1st and 2nd support members, the 1st wheel is pressure-contacted with the 1st support member existing at a side opposite to the 2nd wheel.

Here, it may be constituted such that the spring forms a gap between the 1st and 2nd wheels.

Further, it may be constituted such that the other end portion of the spring is provided with a through-hole through which a shaft for coaxially disposing the 1st and 2nd wheels is inserted.

Further, it may be constituted such that the shaft is constituted integrally with the 1st wheel, and the 2nd wheel is inserted through the shaft.

Further, it may be constituted such that the 1st wheel is a second chronograph wheel.

Further, it may be constituted such that the 2nd wheel is a number two wheel.

Further, it may be constituted such that the 3rd wheel is a second chronograph intermediate wheel.

### BRIEF DESCRIPTION OF THE DRAWINGS

FIG. 1 is a partial front view of a hand motion irregularity suppressed timepiece according to an embodiment of the present invention;

FIG. 2 is a partial plan view of FIG. 1;

FIG. 3 is a view showing an assembling process of the hand motion irregularity suppressed timepiece according to the embodiment of the present invention;

FIG. 4 is a partial front view of a conventional, hand motion irregularity suppressed timepiece;

FIG. 5 is a partial plan view of FIG. 4; and

FIG. 6 is a view showing an assembling process of the conventional, hand motion irregularity suppressed timepiece.

### DETAILED DESCRIPTION OF THE PREFERRED EMBODIMENTS

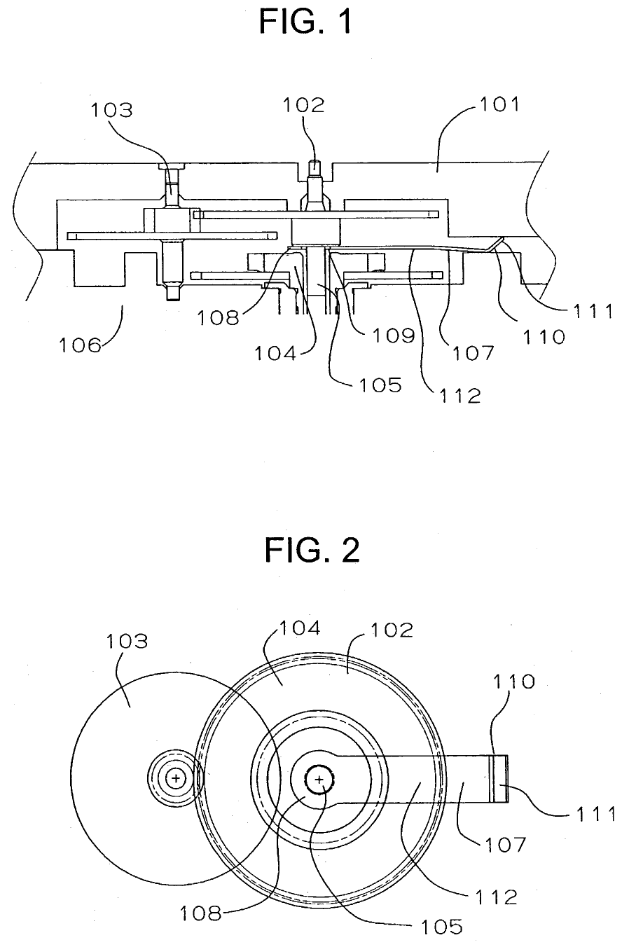

FIG. 1 is a partial front view of a hand motion irregularity suppressed timepiece according to an embodiment of the present invention, and shows an example of chronograph. Further, FIG. 2 is a partial plan view of FIG. 1. Incidentally, FIG. 1 and FIG. 2 are views each showing a state after an assembly of parts such as a wheel has been completed.

In FIG. 1 and FIG. 2, the second chronograph wheel 102 constituting a 1st wheel, the second chronograph intermediate wheel 103 constituting a 3rd wheel and the center wheel 104 constituting a 2nd wheel are disposed between the train wheel bridge 101 constituting a 1st support member and the bottom plate 106 constituting a 2nd support member. The shaft 105 is integrally formed in the second chronograph wheel 102. The center wheel 104 is inserted through the shaft 105, and thus the second chronograph wheel 102 and the center wheel 104 are coaxially disposed. A gear of the second chronograph wheel 102 is meshed with a pinion of the second chronograph intermediate wheel 103.

A spring 107 for suppressing the hand motion irregularity of the second chronograph wheel 102 is disposed between the second chronograph wheel 102 and the center wheel 104.

The spring 107 is an approximately long plate-like form as a whole and so constituted that its part is bent. The spring 107 has a flat portion 112 formed flatly and in a long plate-like form and a bent portion 111 provided in one end portion 110 and bent by a predetermined angle with respect to the flat portion 112 (hereafter, the spring 107 is referred to as cantilever spring).

A through-hole 109 is provided in the other end portion 108 of the flat portion 112. The through-hole 109 is inserted through the shaft 105.

The bent portion 111 is sandwiched and supported by the train wheel bridge 101 and the bottom plate 106 under a pressurized state, and the bent portion 111 is constituted so as to bias the other end portion 108 to the second chronograph wheel 102 side. By this, the second chronograph wheel 102 is biased to the train wheel bridge 101 side by the spring 107 and held under a state of being pressure-contacted with the train wheel bridge 101, and a gap is formed between the second chronograph wheel 102 and the center wheel 104, so that the second chronograph wheel 102 and the center wheel 104 are held under a spaced state without contacting each other.

Accordingly, the hand motion irregularity of the second chronograph wheel 102 is suppressed. Further, since the gap is formed between the second chronograph wheel 102 and the center wheel 104, it becomes possible to prevent the second chronograph wheel 102 from being rotated (so-called accompanying rotation) by a friction when the center wheel 104 is rotated.

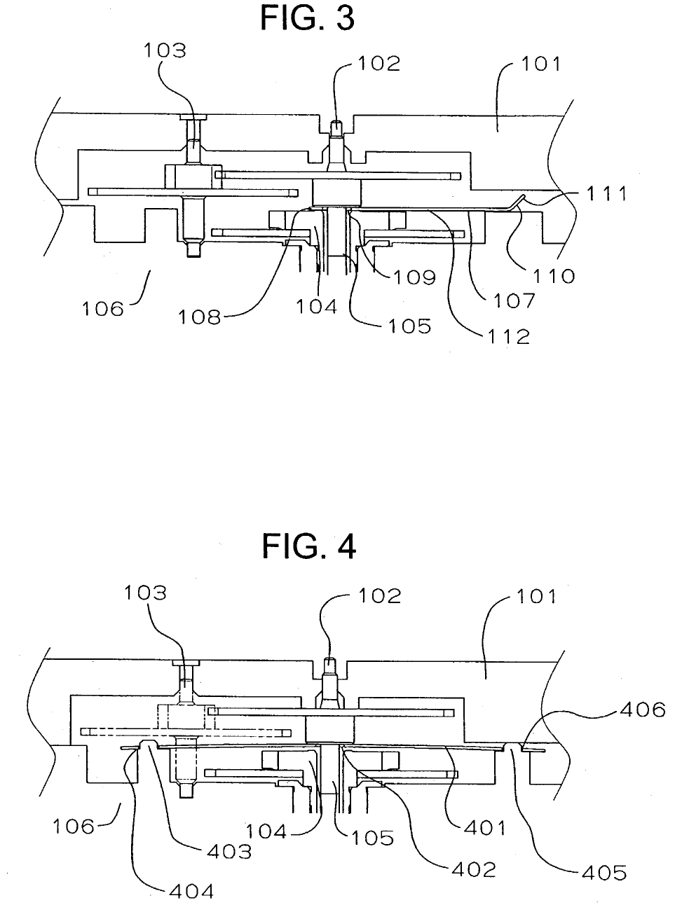

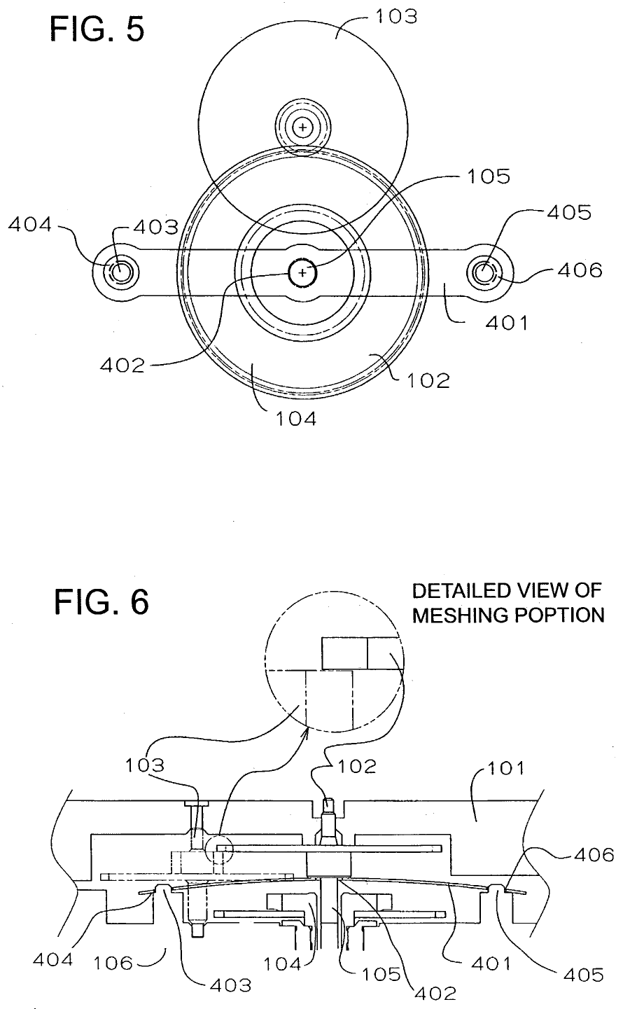

Next, it is explained about a method of assembling the hand motion irregularity suppressed timepiece according to the embodiment. FIG. 3 is a view showing an assembling process of the hand motion irregularity suppressed timepiece according to the embodiment, and the same reference numeral is given to the same portion as FIG. 1 and FIG. 2.

When assembled, after the spring 107 has been mounted on the center wheel 104, the second chronograph intermediate wheel 103 is mounted on the bottom plate 106, next the second chronograph wheel 102 is mounted on the spring 107, and thereafter the train wheel bridge 101 is mounted.

On this occasion, since the second chronograph wheel 102 is mounted on the flat portion 112 of the spring 107, it is unnecessary to push the spring 107 to the bottom plate 106 side in order to align the second chronograph wheel 102 and the second chronograph intermediate wheel 103 to thereby mesh them each other, and accordingly it becomes possible to easily align the second chronograph wheel 102 and the second chronograph intermediate wheel 103 to thereby mesh them each other.

Further, by the fact that the bent portion 111 of the spring 107 is sandwiched and supported by the train wheel bridge 101 and the bottom plate 106 under the pressurized state, the other end portion 108 side of the spring 107 is biased to the train wheel bridge 101 side, so that the second chronograph wheel 102 is pressure-contacted with the train wheel bridge 101 by the spring 107 and thus the hand motion irregularity is suppressed. Additionally, by the fact that the second chronograph wheel 102 is pressure-contacted with the train wheel bridge 101 by the spring 107, the second chronograph wheel 102 becomes impossible to contact with the center wheel 104, so that the accompanying rotation between the second chronograph wheel 102 and the center wheel 104 is prevented.

As mentioned in the above, the hand motion irregularity suppressed timepiece according to the embodiment is characterized in that—in a timepiece adapted such that the second chronograph wheel 102 and the center wheel 104, which are coaxially disposed, and the second chronograph intermediate wheel 103 meshing with the second chronograph wheel 102 are disposed between the train wheel bridge 101 and the bottom plate 106 and the indicating hand is rotated by rotation-driving each of the wheels 102 to 104—there is provided the spring 107 disposed between the second chronograph wheel 102 and the center wheel 104 and having the flat portion 112 and the bent portion 111 formed in one end portion of the flat portion 112, and the second chronograph wheel 102 is pressure-contacted with the train wheel bridge 101 existing at a side opposite to the center wheel 104 by the fact that the flat portion 112 of the spring 107 is disposed between the second chronograph wheel 102 and the center wheel 104 and the bent portion 111 is sandwiched and supported under a pressurized state by the train wheel bridge 101 and the bottom plate 106, so that the assembly is simple and it becomes possible to suppress the hand motion irregularity of the timepiece. Further, it becomes possible to prevent the accompanying rotation between the plural wheels 102, 104 coaxially disposed.

According to the present invention, it becomes possible to provide the hand motion irregularity suppressed timepiece whose assembly is easy.

What is claimed is:

1. A hand motion irregularity suppressed timepiece comprising:
a timepiece adapted such that a 1st wheel and a 2nd wheel, which are coaxially disposed, and a 3rd wheel meshing with the 1st wheel are disposed between a 1st support member and a 2nd support member, and an indicating hand is rotated by rotation-driving each of the wheels; and
a spring disposed between the 1st and 2nd wheels, wherein the spring has a flat portion and a bent portion formed in one end portion of the flat portion, and the 1st wheel is pressure-contacted with the 1st support member existing at a side opposite to the 2nd wheel by the fact that the flat portion of the spring is disposed between the 1st and 2nd wheels and the bent portion is sandwiched and supported under a pressurized state by the 1st and 2nd support members.

2. A hand motion irregularity suppressed timepiece according to claim 1, wherein the spring forms a gap between the 1st and 2nd wheels.

3. A hand motion irregularity suppressed timepiece according to claim 1, wherein the other end portion of the spring is provided with a through-hole through which a shaft for coaxially disposing the 1st and 2nd wheels is inserted.

4. A hand motion irregularity suppressed timepiece according to claim 3, wherein the shaft is constituted integrally with the 1st wheel, and the 2nd wheel is inserted through the shaft.

5. A hand motion irregularity suppressed timepiece according to claim 1, wherein the 1st wheel is a second chronograph wheel.

6. A hand motion irregularity suppressed timepiece according to claim 1, wherein the 2nd wheel is a number two wheel.

7. A hand motion irregularity suppressed timepiece according to claim 1, wherein the 3rd wheel is a second chronograph intermediate wheel.
